(19) United States
(12) Patent Application Publication
(10) Pub. No.: US 2011/0036098 A1
(43) Pub. Date: Feb. 17, 2011

(54) SELF-REGULATING COOLING WATER SYSTEM FOR INTERCOOLED GAS TURBINE ENGINES

(75) Inventor: Robert Allen Baten, Houston, TX (US)

Correspondence Address: GE Energy-Global Patent Operation;Fletcher Yoder PC, P.O. Box 692289, Houston, TX, 77269-2289, US

(73) Assignee: GENERAL ELECTRIC COMPANY, Schenectady, NY (US)

(21) Appl. No.: 12/542,598

(22) Filed: Aug. 17, 2009

(51) Int. Cl. F02C 7/12; F04D 15/00

(52) U.S. Cl. 60/806; 415/47

(57) ABSTRACT

In certain embodiments, a system includes an inter-section fluid cooling system. The inter-section fluid cooling system includes an intercooler configured to receive heated air from a first section of a turbine compressor system, to cool the heated air with a cooling fluid mixture to generate cooled air, and to deliver the cooled air to a second section of the turbine compressor system. The inter-section fluid cooling system also includes a pump configured to pump the cooling fluid mixture into the intercooler.

### BACKGROUND OF THE INVENTION

The subject matter disclosed herein relates to gas turbine intercooling systems. More specifically, the disclosed embodiments relate to systems and methods for maintaining a substantially constant temperature of cooled compressed air from a gas turbine intercooling system.

Gas turbine systems often include multiple compression sections. As air is compressed in each compression section, both the pressure and temperature of the air increases. To minimize temperatures in downstream compression sections, the heated compressed air is often directed into an inter-section intercooling system, where the heated compressed air is cooled before being directed into subsequent compression sections. The intercooling systems may often be somewhat complicated, requiring numerous components and subsystems. In addition, when water is used as a cooling medium in the intercooling systems, cavitation and fouling may often occur, leading to decreases in performance.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine intercooling system. The gas turbine intercooling system includes an intercooler configured to cool air received from a first compressor section of a gas turbine with a coolant mixture and to deliver the cooled air to a second compressor section of the gas turbine. The gas turbine intercooling system also includes a thermostatic control valve configured to mix a first stream of coolant from the intercooler with a second stream of coolant from a coolant source to generate the coolant mixture. The gas turbine intercooling system further includes a pump configured to pump the coolant mixture from the thermostatic control valve into the intercooler.

In a second embodiment, a system includes an inter-section water cooling system. The inter-section water cooling system includes a water cooling tower configured to generate a first stream of cooling water. The inter-section water cooling system also includes an intercooler configured to receive heated air from a first section of a turbine compressor system, to cool the heated air with a cooling water mixture to generate cooled air, and to deliver the cooled air to a second section of the turbine compressor system. The inter-section water cooling system further includes a thermostatic control valve configured to mix the first stream of cooling water from the water cooling tower with a second stream of cooling water from the intercooler to generate the cooling water mixture.

In a third embodiment, a system includes an inter-section fluid cooling system. The inter-section fluid cooling system includes an intercooler configured to receive heated air from a first section of a turbine compressor system, to cool the heated air with a cooling fluid mixture to generate cooled air, and to deliver the cooled air to a second section of the turbine compressor system. The inter-section fluid cooling system also includes a pump configured to pump the cooling fluid mixture into the intercooler.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary embodiment of a gas turbine system having an intercooling system;

FIG. 2 is a schematic flow diagram of an exemplary embodiment of the gas turbine system having the intercooling system and a plurality of compressor and turbine sections;

FIG. 3 is a schematic flow diagram of an exemplary embodiment of the intercooling system of the gas turbine system;

FIG. 4 is a schematic flow diagram of another exemplary embodiment of the intercooling system of the gas turbine system, incorporating a thermostatic control valve and variable-speed pumps;

FIG. 5 is a perspective view of an exemplary embodiment of a water skid of the intercooling system illustrated in FIG. 3; and

FIG. 6 is a perspective view of an exemplary embodiment of the water skid of the intercooling system illustrated in FIG. 4.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include systems and methods for substantially reducing variations in the temperature of cooled compressed air exiting a gas turbine intercooling system. In particular, the disclosed embodiments provide for using a thermostatic control valve and variable-speed pumps to ensure that the temperature of the cooled compressed air exiting the intercooling system remains substantially constant (e.g., within a range of 1-2° F.). Using the thermostatic control valve and variable-speed pumps may substantially reduce the footprint of the intercooling system, substantially reduce the number of components used in the intercooling system, and substantially reduce the overall cost of the intercooling system. In addition, the disclosed embodiments may substantially reduce cavitation in valves of the intercooling system. Furthermore, the disclosed embodiments may enable the intercooling system to self-compensate for efficiency reductions, which may occur over time due to fouling in an intercooler of the intercooling system.

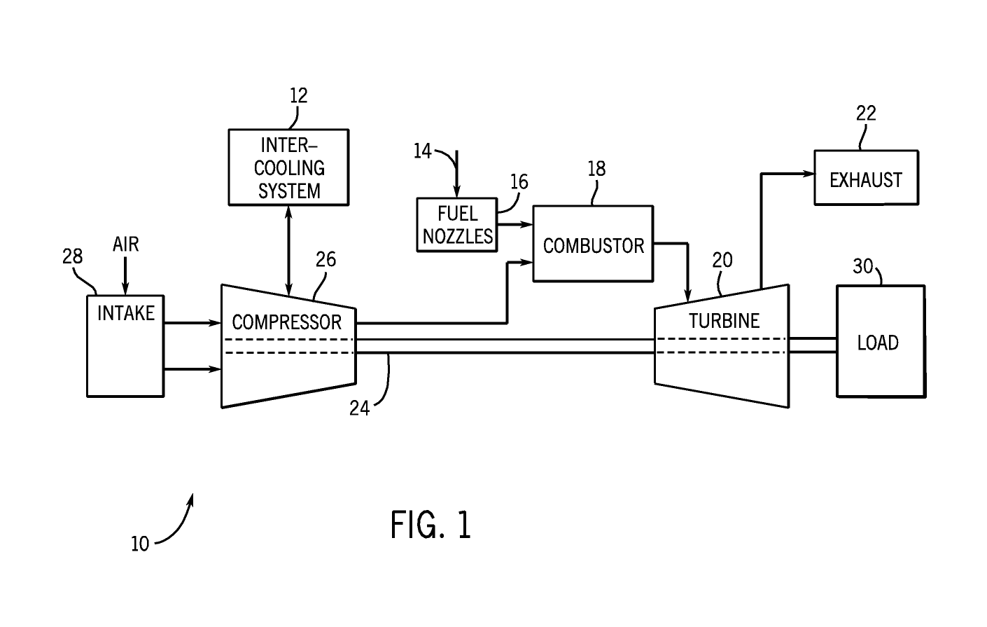

FIG. 1 is a schematic flow diagram of an embodiment of a gas turbine system 10 having an intercooling system 12. As described in greater detail below, the intercooling system 12 may be configured to cool compressed air between multiple compression sections of the gas turbine system 10. In particular, the intercooling system 12 may provide two methods, used in combination, for controlling the temperature of the cooled compressed air returning to the gas turbine system 10 from the intercooling system 12. The first method is the utilization of a thermostatic control valve that mixes cooling water returning from an intercooler of the intercooling system 12 with cooling water returning from a cooling tower of the intercooling system 12. The thermostatic control valve may maintain a substantially constant temperature of cooling water provided to the intercooler. This control may be somewhat coarse and is intended to give the intercooling system 12 a stable reference temperature at which to operate. The second method is the utilization of variable-speed pumps to provide cooling water at the stabilized temperature to the intercooler. As the air side heat load to the intercooler increases, the pump speed may increase to provide more cooling water. Conversely, as the air side heat load decreases, the pump speed may decrease to provide less cooling water. The pump speed may be controlled by a closed loop circuit using the temperature of the cooled compressed air exiting the intercooler as a reference set point to be maintained. The use of variable-speed pumps and the associated flow control circuit may provide finer tuning of the temperature of the cooled compressed air exiting the intercooler.

The gas turbine system 10 may use liquid or gas fuel 14, such as natural gas and/or a hydrogen rich synthetic gas. As depicted, a plurality of fuel nozzles 16 intakes the fuel supply 14, mixes the fuel with air, and distributes the air-fuel mixture into a combustor 18. For example, the fuel nozzles 16 may inject the air-fuel mixture into the combustor 18 in a suitable ratio for optimal combustion, emissions, fuel consumption, and power output. The air-fuel mixture combusts in a chamber within the combustor 18, thereby creating hot pressurized exhaust gases. The combustor 18 directs the exhaust gases through a turbine 20 toward an exhaust outlet 22. As the exhaust gases pass through the turbine 20, the gases force one or more turbine blades to rotate a shaft 24 along an axis of the gas turbine system 10. As illustrated, the shaft 24 may be connected to various components of the gas turbine system 10, including a compressor 26. The compressor 26 also includes blades that may be coupled to the shaft 24. As the shaft 24 rotates, the blades within the compressor 26 also rotate, thereby compressing air from an air intake 28 through the compressor 26 and into the fuel nozzles 16 and/or combustor 18. The shaft 24 may also be connected either mechanically or aerodynamically to a load 30, which may be a vehicle or a stationary load, such as an electrical generator in a power plant or a propeller on an aircraft, for example. The load 30 may include any suitable device capable of being powered by the rotational output of the gas turbine system 10.

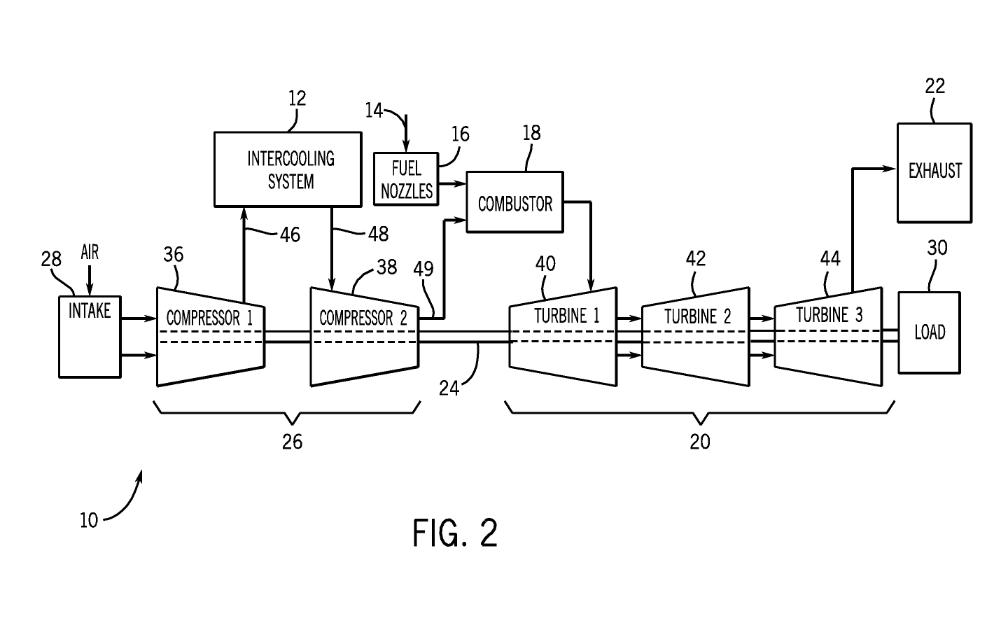

FIG. 2 is a schematic flow diagram of an exemplary embodiment of the gas turbine system 10 having an intercooling system 12 and a plurality of compressor 26 and turbine 20 sections. In particular, the gas turbine system 10 illustrated in FIG. 2 includes two compressor sections 36, 38 and three turbine sections 40, 42, 44. In certain embodiments, the first compressor section 36 may be a low-pressure compressor, such as a booster, whereas the second compressor section 38 may be an intermediate-pressure or high-pressure compressor. In addition, in certain embodiments, the first turbine section 40 may be a high-pressure turbine, the second turbine section 42 may be an intermediate-pressure turbine, and the third turbine section 44 may be a power turbine. However, in other embodiments, the plurality of compressor sections 36, 38 and turbine sections 40, 42, 44 may include other combinations of compressors and turbines.

In certain embodiments, however, air from the air intake 28 may be compressed within the first compressor section 36 to generate heated compressed air 46. As described in greater detail below, the heated compressed air 46 may be cooled within the intercooling system 12 to generated cooled compressed air 48 which may be directed into the second compressor section 38, where the cooled compressed air 48 may be further compressed to generate the compressed air 49, which may be mixed with the fuel 14 within the combustor 18 of the gas turbine system 10. Therefore, the intercooling system 12 may be configured to reduce the temperature of heated compressed air 46 from the first compressor section 36 so that the cooled compressed air 48, which is further compressed within the second compressor section 38, remains under a given temperature threshold. In doing so, the temperature ratings of the second compressor section 38 may be reduced, thereby reducing the cost of the gas turbine system 10. For example, the design limits of the materials used for the second compressor section 38 may be reduced, leading to reductions in the cost of materials used in the second compressor section 38. In addition, the use of the cooled compressed air 48 within the second compressor section 38 may increase overall efficiency and power output of the gas turbine system 10.

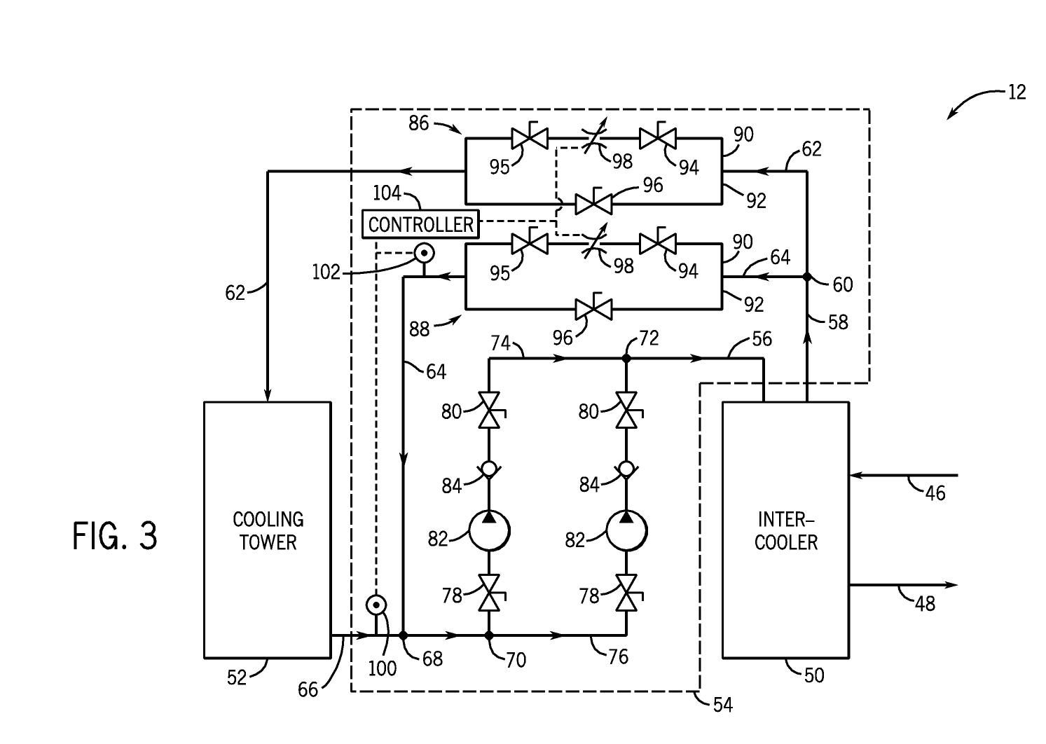

FIG. 3 is a schematic flow diagram of an exemplary embodiment of the intercooling system 12 of the gas turbine system 10. As illustrated, in certain embodiments, the intercooling system 12 may include an intercooler 50, a cooling tower 52 (e.g., a coolant source), and a coolant skid 54 (e.g., a cooling water skid) configured to transfer a coolant (e.g., cooling water) to and from the intercooler 50 and the cooling tower 52. As described above, the intercooler 50 may be configured to receive heated compressed air 46 from the first compressor section 36, to cool the heated compressed air 46 to generate cooled compressed air 48, and to direct the cooled compressed air 48 to the second compressor section 38. The intercooler 50 may use cooling water received from an intercooling water input line 56 to cool the heated compressed air 46. In certain embodiments, the intercooler 50 may include tube and shell type heat exchangers. However, other types of heat exchangers may also be used within the intercooler 50. Heat may be transferred from the heated compressed air 46 to the cooling water during cooling of the heated compressed air 46. As such, heated cooling water may be generated and may subsequently be transferred from the intercooler 50 via an intercooling water output line 58.

In certain embodiments, the flow of heated cooling water may be split into two flow streams at a cooling water junction point 60. In particular, a first flow stream of heated cooling water may be split into a cooling tower water return line 62 and a second flow of heated cooling water may be split into an intercooler water return line 64. The first flow stream of heated cooling water in the cooling tower water return line 62 is directed into the cooling tower 52, while the second flow stream of heated cooling water in the intercooler water return line 64 is directed back to the intercooler 50. As such, the first flow stream of heated cooling water in the cooling tower water return line 62 is cooled by the cooling tower 52, whereas the second flow stream of heated cooling water in the intercooler water return line 64 is not cooled before re-entering the intercooler 50. The cooling tower 52 may be configured to receive the first flow stream of heated cooling water and to generate cooled cooling water, which may be transferred from the cooling tower 52 via a cooling tower water output line 66.

The cooled cooling water from the cooling tower 52 in the cooling tower water output line 66 may be mixed with the heated cooling water in the intercooler water return line 64 at a cooling water mixture point 68. After being mixed together at the cooling water mixture point 68, the cooling water may be pumped from the pump inlet point 70 to a pump outlet point 72 through either a first pump line 74 or a second pump line 76. The first and second pump lines 74, 76 may contain substantially similar equipment and may be used primarily for redundancy purposes. In other words, only one of the first or second pump lines 74, 76 may be used at a time. For example, in certain embodiments, both the first and second pump lines 74, 76 may include an upstream isolation valve 78 and a downstream isolation valve 80 for isolating one or the other pump line 74, 76, enabling the other pump line 74, 76 to pump the cooling water from the pump inlet point 70 to the pump outlet point 72. In addition, both the first and second pump lines 74, 76 include a pump 82 for pumping the cooling water from the pump inlet point 70 to the pump outlet point 72. In certain embodiments, the pumps 82 may be fixed-speed pumps for providing a substantially constant flow of cooling water into the intercooler 50 through the intercooling water input line 56, downstream of the pump outlet point 72. In addition, in certain embodiments, both the first and second pump lines 74, 76 may include check valves 84 for controlling the flow of cooling water though the respective pump lines 74, 76.

As described above, the embodiment illustrated in FIG. 3 is configured to provide a substantially constant flow of cooling water into the intercooler 50. In addition, in certain embodiments, the temperature of the cooling water into the intercooler 50 may be controlled while maintaining a substantially constant flow of cooling water into the intercooler 50. This may generally ensure that the temperature of the cooled compressed air 48 exiting the intercooler 50 may remain at a substantially constant temperature. In particular, the difference between the temperature of the cooling water into the intercooler 50 and the temperature of the cooled compressed air exiting the intercooler 50 may be referred to as the “approach temperature.” For a given application within a particular range of flow rates and temperature limits, the approach temperature may remain substantially constant as long as the flow of cooling water into the intercooler 50 remains substantially constant, regardless of the heat load (e.g., the amount of heat to be removed from the heated compressed air 46) being input on the air side (e.g., from the heated compressed air 46) of the intercooler 50.

To ensure that the cooling water into the intercooler 50 remains at a substantially constant flow rate and a substantially constant temperature, the mixing of the cooled cooling water from the cooling tower 52 in the cooling tower water output line 66 and the heated cooling water in the intercooler water return line 64 at the cooling water mixture point 68 may be controlled. More specifically, a cooling tower valve control section 86 and an intercooler valve control section 88 may be used to control the distribution between the first flow stream of heated cooling water in the cooling tower water return line 62 and the second flow stream of heated cooling water in the intercooler water return line 64. The cooling tower valve control section 86 and the intercooler valve control section 88 may be located in-line with the cooling tower water return line 62 and the intercooler water return line 64, respectively. Both valve control sections 86, 88 may include substantially similar equipment. For example, in certain embodiments, both valve control sections 86, 88 may include a primary flow path 90 and a bypass flow path 92. In certain embodiments, the primary flow paths 90 of the valve control sections 86, 88 may include an upstream isolation valve 94 and a downstream isolation valve 95 for isolating the respective primary flow paths 90 from the respective bypass flow paths 92. In addition, in certain embodiments, the bypass flow paths 92 may include a bypass valve 96.

The distribution between the first flow stream of heated cooling water in the cooling tower water return line 62 and the second flow stream of heated cooling water in the intercooler water return line 64 may generally be accomplished by a throttling valve 98 in the primary flow paths 90 of each of the valve control sections 86, 88. For example, the throttling valve 98 in the primary flow path 90 of the cooling tower valve control section 86 may generally control the first flow stream of heated cooling water in the cooling tower water return line 62, while the throttling valve 98 in the primary flow path 90 of the intercooler valve control section 88 may generally control the second flow stream of heated cooling water in the intercooler water return line 64. In certain embodiments, the throttling valves 98 may be controlled based on the temperature of the cooled cooling water from the cooling tower 52 in the cooling tower water output line 66 and the temperature of the heated cooling water in the intercooler water return line 64. In particular, in certain embodiments, a cooled cooling water temperature sensor 100 may measure the temperature of the cooled cooling water from the cooling tower 52 in the cooling tower water output line 66 and a heated cooling water temperature sensor 102 may measure the temperature of the heated cooling water in the intercooler water return line 64. These temperature measurements may be used by the throttling valves 98 to determine how to distribute the flow of heated cooling water between the first flow stream in the cooling tower water return line 62 and the second flow stream in the intercooler water return line 64 to ensure that the cooling water into the intercooler 50 remains at a substantially constant flow rate and a substantially constant temperature. For example, in certain embodiments, a controller 104 may be used to adjust the throttling valves 98 based on the temperatures measured by the cooled cooling water temperature sensor 100 and the heated cooling water temperature sensor 102.

However, the embodiment illustrated in FIG. 3 includes a fairly complex system of valves in the valve control sections 86, 88 to ensure that the cooling water into the intercooler 50 remains at a substantially constant flow rate and a substantially constant temperature. In addition, the control system accomplished by the valve control sections 86, 88 and the controller 104 may only indirectly control the temperature and flow rate of the cooling water into the intercooler 50 by throttling the substantially constant flow of heated cooling water between the first flow stream in the cooling tower water return line 62 and the second flow stream in the intercooler water return line 64. This may be due, at least in part, to the fact that the fixed-speed pumps 82, in certain circumstances, may provide too much head, which the throttling valves 98 and the check valves 84 may limit to a certain degree. Although the throttling valves 98 and the check valves 84 may reduce the flow rate of cooling water, the pressure drop across the throttling valves 98 and the check valves 84 may lead to cavitation on a downstream side of the valves. In addition to the unwanted noise caused by the cavitation, accelerated wear of the valves may also be experienced.

As described above, the substantially constant flow of cooling water into the intercooler 50 is accomplished by the fact that fixed-speed pumps 82 may be used. However, another alternative may be to use variable-speed pumps and to adjust the cooling water flow between the first flow stream in the cooling tower water return line 62 and the second flow stream in the intercooler water return line 64 using a thermostatic control valve.

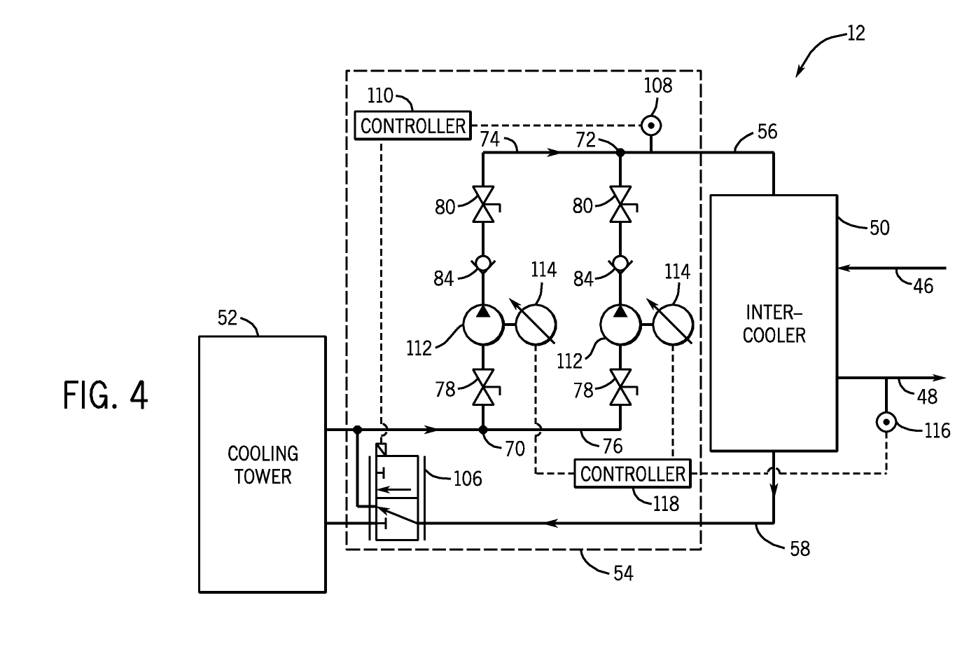

For example, FIG. 4 is a schematic flow diagram of another exemplary embodiment of the intercooling system 12 of the gas turbine system 10. As illustrated, instead of using the valve control sections 86, 88, a thermostatic control valve 106 may be connected to the intercooling water output line 58. The thermostatic control valve 106 may be a control valve configured to selectively mix a cooler fluid with a hotter fluid to generate a constant-temperature fluid mixture. In particular, the thermostatic control valve 106 may be configured to accept heated cooling water from the intercooler 50 and cooled cooling water from the cooling tower 52 and output a cooling water mixture at a predetermined temperature somewhere between the temperature of the heated cooling water from the intercooler 50 and the temperature of the cooled cooling water from the cooling tower 52. In particular, the thermostatic control valve 106 may be configured to maintain a substantially constant temperature of cooling water into the intercooler 50 through the intercooling water input line 56. As such, in certain embodiments, an intercooler water inlet sensor 108 in the intercooling water input line 56 may provide feedback to the thermostatic control valve 106 relating to the temperature of the cooling water into the intercooler 50. In certain embodiments, the logic for determining how to mix the heated cooling water and cooled cooling water streams may be internal to the thermostatic control valve 106. However, in other embodiments, an external controller 110 may control the operation of the thermostatic control valve 106.

Using the thermostatic control valve 106 to mix the heated and cooled cooling water streams may provide a relatively coarse level of control which may be supplemented by the use of variable-speed pumps 112 instead of the fixed speed pumps 82 described above with respect to the embodiment illustrated in FIG. 3. However, the thermostatic control valve 106 will generally establish a stable reference temperature for the intercooling system 12.

As illustrated, both the first and second pump lines 74, 76 may include a variable-speed pump 112, each driven by a respective variable-speed motor 114. As described above with respect to the fixed-speed pumps 82 illustrated in FIG. 3, the variable-speed pumps 112 may, in certain embodiments, be operated one at a time with the other variable-speed pump 112 being used for redundancy purposes. However, since the variable-speed pumps 112 are capable of operating at a wider range of speeds, both variable-speed pumps 112 may be operated at the same time under certain circumstances. Therefore, among other benefits discussed below, using variable-speed pumps 112 may lead to more flexibility in the operation of the intercooling system 12, as well as enabling more accurate control of the delivery of cooling water into the intercooler 50.

As the air side heat load (e.g., from the heated compressed air 46) to the intercooler 50 increases, the speed of the variable-speed pumps 112 may be increased by the respective variable-speed motors 114 to provide more cooling water to the intercooler 50. Conversely, as the air side heat load decreases, the speed of the variable-speed pumps 112 may be decreased by the respective variable-speed motors 114 to provide less cooling water to the intercooler 50. In certain embodiments, the operating speed of the variable-speed pumps 112 may be controlled by a closed loop circuit using the temperature of the cooled compressed air 48 exiting the intercooler 50 as a reference set point to be maintained. As such, in certain embodiments, an intercooler air outlet sensor 116 may provide feedback to the variable-speed motors 114 relating to the temperature of the cooled compressed air 48 exiting the intercooler 50. In certain embodiments, the logic for determining how to vary the speed of the variable-speed pumps 112 may be internal to the variable-speed motors 114. However, in other embodiments, an external controller 118 may control the operation of the variable-speed pumps 112 via the variable-speed motors 114.

Using the variable-speed pumps 112 to vary the amount of cooling water delivered to the intercooler 50 through the intercooling water input line 56 may provide fine tuning of the temperature of the cooled compressed air 48 exiting the intercooler 50. In addition, using the variable-speed pumps 112 may enable the intercooling system 12 to operate at the minimum flow rate and pressure necessary, as opposed to generating higher flow rates and pressures which require throttling, to provide a substantially constant temperature of the cooled compressed air 48 exiting the intercooler 50. Furthermore, the possibility of cavitation in the valves may be substantially reduced. For example, all of the valves in the valve control sections 86, 88 discussed above with respect to the embodiment illustrated in FIG. 3 may be replaced by the thermostatic control valve 106. In addition, the need to reduce the flow of cooling water through the pump lines 74, 76 using the check valves 84 may be substantially reduced since variable-speed pumps 112 are used. For example, the variable-speed pumps 112 substantially reduce cavitation in the intercooling system 12 by reducing the head from the variable-speed pumps 112 to only a level needed to circulate cooling water through the intercooler 50. Numerous valves (e.g., the valve control sections 86, 88) are no longer needed to reduce the pressure and flow of the cooling water and, thus, the occurrence of cavitation may be substantially reduced.

Therefore, the use of the thermostatic control valve 106 and the variable-speed pumps 112 may enable both a course and a fine level of control over the temperature and flow rate of the cooling water into the intercooler 50 to ensure that the temperature of the cooled compressed air 48 exiting the intercooler 50 remains substantially constant. However, although discussed above as working in tandem, these two control techniques may, in fact, be used independently. For example, in certain embodiments, the thermostatic control valve 106 may be used with the fixed-speed pumps 82 discussed above with respect to the embodiment illustrated in FIG. 3. In such an embodiment, the flow rate of cooling water through the intercooler 50 may remain substantially constant while the thermostatic control valve 106 varies the temperature of the cooling water through the intercooler 50 by varying the mixture of heated cooling water from the intercooler 50 and cooled cooling water from the cooling tower 52.

Alternatively, in other embodiments, the variable-speed pumps 112 may be used with the valve control sections 86, 88 discussed above with respect to the embodiment illustrated in FIG. 3. In such an embodiment, the valve control sections 86, 88 may vary the flow between the first flow stream in the cooling tower water return line 62 of FIG. 3 and the second flow stream in the intercooler water return line 64 of FIG. 3 to ensure that the cooling water into the intercooler 50 remains at a substantially constant temperature. Then, the variable-speed pumps 112 may adjust the flow rate of the substantially constant temperature cooling water into the intercooler 50 to make minor adjustments such that the temperature of the cooled compressed air 48 exiting the intercooler 50 remains substantially constant.

Technical effects of the disclosed embodiments include providing systems and methods for maintaining a substantially constant temperature of the cooled compressed air 48 exiting the intercooler 50 of the intercooling system 12 and returning to the second compressor section 38 of the gas turbine system 10. In particular, the disclosed embodiments provide two primary methods for controlling the temperature and flow rate of cooling water into the intercooler 50. The first method is the utilization of the thermostatic control valve 106 that mixes cooling water returning from an intercooler 50 of the intercooling system 12 with cooler cooling water returning from the cooling tower 52 of the intercooling system 12. The second method is the utilization of the variable-speed pumps 112 to provide cooling water to the intercooler 50 at the stabilized temperature.

As described above, in certain embodiments, these control methods may be performed by the controllers 110, 118 based on temperature measurements sensed by the intercooler water inlet sensor 108 and the intercooler air outlet sensor 116, respectively. The controllers 110, 118 may, in certain embodiments, be physical computing devices specifically configured to obtain (e.g., receive) the sensed temperature measurements and to control the thermostatic control valve 106 and the variable-speed pumps 112, respectively, based on the sensed temperature measurements. More specifically, the controllers 110, 118 may include input/output (I/O) devices for receiving the sensed temperature measurements and a memory device and a machine-readable medium with instructions encoded thereon for determining how to control the thermostatic control valve 106 and the variable-speed pumps 112, respectively. In addition, in certain embodiments, the controllers 110, 118 may also include storage media for storing historical data, theoretical performance curves, and so forth.

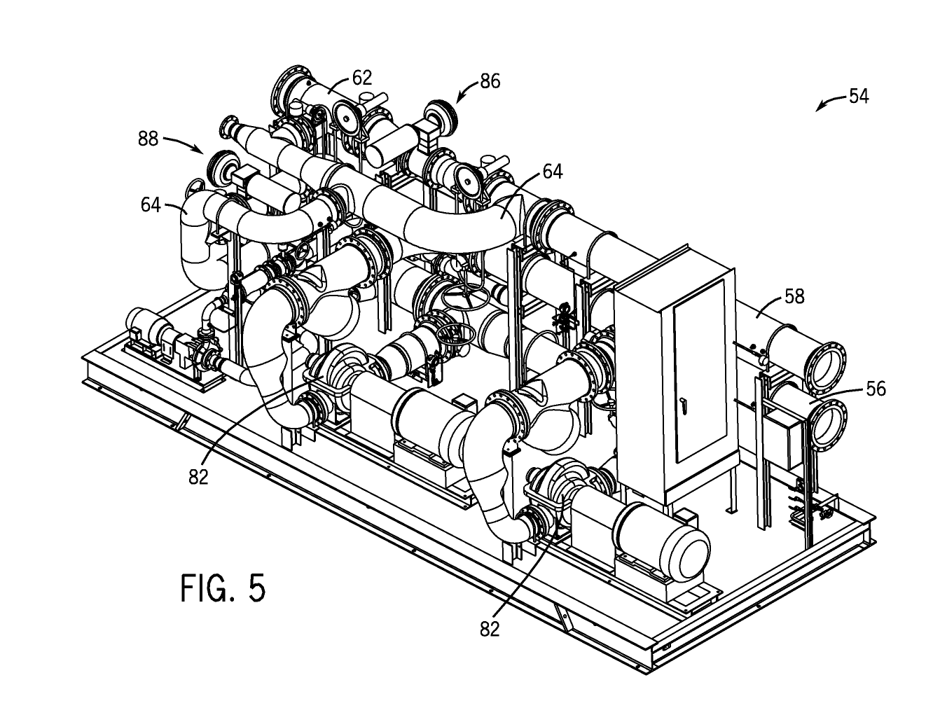

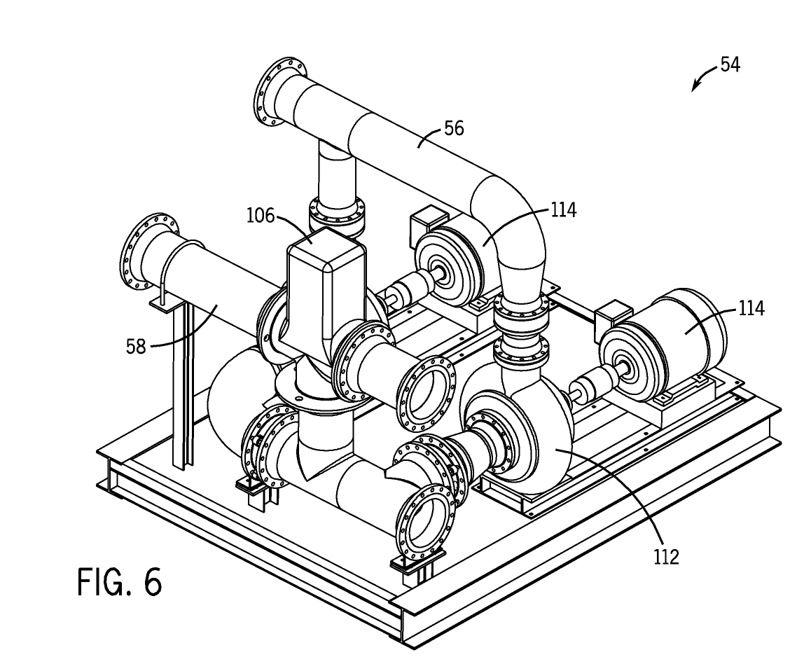

The embodiments disclosed herein provide several advantages. For example, the embodiment illustrated in FIG. 4 may substantially reduce the footprint required for the cooling water skid 54 by, for instance, 20%, 30%, 40%, 50%, 60%, or more. For instance, the thermostatic control valve 106 replaces the cooling tower water return line 62, the intercooler water return line 64, and the valve control sections 86, 88 of FIG. 3. Therefore, the embodiment illustrated in FIG. 4 may cost substantially less than the embodiment illustrated in FIG. 3, due at least in part to the reduced number of components used on the cooling water skid 54. In addition, due to the simplicity of the embodiment illustrated in FIG. 4, the intercooling system 12 may be more reliable, with accuracy as good or better than that provided by the embodiment illustrated in FIG. 3. To illustrate the substantial reduction in footprint and number of components used, FIGS. 5 and 6 illustrate perspective views of the exemplary embodiments of the cooling water skids 54 depicted schematically in FIGS. 3 and 4, respectively. As shown, FIG. 6 illustrates a cooling water skid 54 with substantially fewer components and taking up a substantially smaller footprint than that of FIG. 5. As described above, removal of the cooling tower water return line 62, the intercooler water return line 64, and the valve control sections 86, 88 is a primary reason for the reduction of components.

In addition to the reduced footprint, reduced number of components, reduction in overall costs, and increased reliability and accuracy, the embodiments disclosed herein may also substantially reduce the occurrence of cavitation. In particular, the variable-speed pumps 112 illustrated in FIG. 4 generate only enough head needed to circulate cooling water through the intercooler 50. As such, the need to reduce flow rates of the cooling water using the throttling valve 98, check valves 84, and other valves may be substantially reduced and, thus, the occurrence of cavitation in the valves may also be substantially reduced.

In addition, the embodiments disclosed herein may self-compensate for the loss of cooling capability of the intercooler 50. As fouling occurs in the intercooler 50 over time, the cooling efficiency of the intercooler 50 may reduce substantially. In typical intercooling systems, maintaining the temperature of the cooled compressed air 48 exiting the intercooler 50 may depend on the approach temperature of the intercooler 50. However, as the intercooler 50 fouls over time, the approach temperature changes. The embodiments disclosed herein self-correct for fouling and provide stable temperatures of the cooled compressed air 48 exiting the intercooler 50, regardless of the amount of fouling in the intercooler 50. In addition, although illustrated and described herein as an inter-section water cooling system, in certain embodiments, the intercooling system 12 may be configured to use other types of coolant, instead of water.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. A system, comprising:
a gas turbine intercooling system, comprising:
an intercooler configured to cool air received from a first compressor section of a gas turbine with a coolant mixture and to deliver the cooled air to a second compressor section of the gas turbine;
a thermostatic control valve configured to mix a first stream of coolant from the intercooler with a second stream of coolant from a coolant source to generate the coolant mixture; and
a pump configured to pump the coolant mixture from the thermostatic control valve into the intercooler.

2. The system of claim 1, wherein the thermostatic control valve is configured to selectively mix the first and second streams of coolant to maintain a substantially constant temperature of the coolant mixture into the intercooler.

3. The system of claim 1, wherein the pump comprises a variable speed pump configured to vary the operating speed to maintain a substantially constant temperature of the cooled air delivered from the intercooler to the second compressor section of the gas turbine.

4. The system of claim 1, wherein the gas turbine intercooling system comprises a plurality of pumps operating in parallel to pump the coolant mixture from the thermostatic control valve into the intercooler.

5. The system of claim 1, comprising the gas turbine, wherein the first compressor section of the gas turbine comprises a low-pressure compressor and the second compressor section of the gas turbine comprises a high-pressure compressor.

6. The system of claim 1, wherein the gas turbine intercooling system comprises the coolant source configured to receive a portion of the first stream of coolant from the intercooler and to generate the second stream of coolant.

7. A system, comprising:
an inter-section water cooling system, comprising:
a water cooling tower configured to generate a first stream of cooling water;
an intercooler configured to receive heated air from a first section of a turbine compressor system, to cool the heated air with a cooling water mixture to generate cooled air, and to deliver the cooled air to a second section of the turbine compressor system; and
a thermostatic control valve configured to mix the first stream of cooling water from the water cooling tower with a second stream of cooling water from the intercooler to generate the cooling water mixture.

8. The system of claim 7, wherein the thermostatic control valve is configured to selectively mix the first and second streams of cooling water to maintain a substantially constant temperature of the cooling water mixture into the intercooler.

9. The system of claim 7, wherein the inter-section water cooling system comprises a variable speed pump configured to pump the cooling water mixture from the thermostatic control valve into the intercooler.

10. The system of claim 9, wherein the variable speed pump is configured to vary the operating speed of the variable speed pump to maintain a substantially constant temperature of the cooled air delivered from the intercooler to the second section of the turbine compressor system.

11. The system of claim 9, wherein the inter-section water cooling system comprises a plurality of variable speed pumps operating in parallel to pump the cooling water mixture from the thermostatic control valve into the intercooler.

12. The system of claim 7, wherein the first section of the turbine compressor system comprises a low-pressure compressor and the second section of the turbine compressor system comprises a high-pressure compressor.

13. The system of claim 7, wherein the water cooling tower is configured to receive a portion of the second stream of cooling water from the intercooler.

14. A system, comprising:
an inter-section fluid cooling system, comprising:
an intercooler configured to receive heated air from a first section of a turbine compressor system, to cool the heated air with a cooling fluid mixture to generate cooled air, and to deliver the cooled air to a second section of the turbine compressor system; and
a pump configured to pump the cooling fluid mixture into the intercooler.

15. The system of claim 14, wherein the pump comprises a variable speed pump configured to vary the operating speed to maintain a substantially constant temperature of the cooled air delivered from the intercooler to the second section of the turbine compressor system.

16. The system of claim 14, wherein the inter-section fluid cooling system comprises a plurality of pumps operating in parallel to pump the cooling fluid mixture into the intercooler.

17. The system of claim 14, wherein the inter-section fluid cooling system comprises a thermostatic control valve configured to selectively mix a first stream of cooling fluid from a cooling tower with a second stream of cooling fluid from the intercooler to generate the cooling fluid mixture.

18. The system of claim 17, wherein the thermostatic control valve is configured to selectively mix the first and second streams of cooling fluid to maintain a substantially constant temperature of the cooling fluid mixture into the intercooler.

19. The system of claim 17, wherein the inter-section fluid cooling system comprises the fluid cooling tower configured to receive a portion of the second stream of cooling fluid from the intercooler.

20. The system of claim 14, wherein the first section of the turbine compressor system comprises a low-pressure compressor and the second section of the turbine compressor system comprises a high-pressure compressor.
